(19) United States
(12) Patent Application Publication
(10) Pub. No.: US 2007/0034233 A1
(43) Pub. Date: Feb. 15, 2007

(54) Washout devices, systems and methods

(75) Inventors: Brian D. Ham, Tucson, AZ (US); Gary E. Florian, Tucson, AZ (US); Garrett S. Ham, Sahuarita, AZ (US)

Correspondence Address: KIRKPATRICK & LOCKHART NICHOLSON GRAHAM LLP, 535 SMITHFIELD STREET, PITTSBURGH, PA, 15222, US

(73) Assignee: Washout Systems, LLC

(21) Appl. No.: 11/202,602

(22) Filed: Aug. 12, 2005

(51) Int. Cl. B08B 7/04; B08B 3/00

(52) U.S. Cl. 134/10; 134/137; 134/147

(57) ABSTRACT

Washout systems, devices and methods are disclosed for cleaning objects, tools, parts, etc. with a cleaning agent and collecting the cleaning agent, debris and waste material created during the cleaning process in a container for reclamation or disposal.

### BACKGROUND OF THE INVENTION

1. Field of the Invention

The invention relates to waste management devices, systems and methods and, more particularly, to devices, systems and methods used to facilitate the cleanup of tools, parts, etc. with a cleaning medium and collecting the spent cleaning medium, debris and waste materials in a container for temporary storage prior to appropriate disposal or reclamation.

2. Description of the Invention Background

Over the years, many environmental laws and initiatives have been established regarding the safe disposal of various types of chemicals and the cleaning agents that are commonly used to clean or remove those chemicals from tools, parts, machines, etc. In the building construction industry for example, many of these initiatives and laws require that chemicals such as paint, oil, grease, solvents, drywall, gypsum, etc. to be properly disposed of and removed from the jobsite to prevent contamination of the surrounding environment. Similar initiatives and laws apply to manufacturing operations such as machine shops, fabricators, etc. that use chemicals in various operations that must be cleaned from tools and machine parts and thereafter safely disposed of.

Thus, as can be appreciated from the forgoing discussion, there is a need for washout devices, systems, and methods that may be used in connection with various cleaning agents, water, etc. to clean tools, parts, etc. and facilitate the collection of the cleaning agent and resulting debris and waste created during the cleaning process in a container for transport away from the jobsite or facility for further reclamation or disposal or for pumping the cleaning waste liquid into a mobile container for hauling off site.

### SUMMARY

In accordance with one embodiment of the present invention, there is provided a washout device for use in connection with a container having an end within an opening therein. One embodiment of the washout device comprises a support member that has openings therethrough. The support member is sized to be received in the container opening. This embodiment further comprises at least one cleaning basin that is movably affixed to the support member. The cleaning basin is selectively movable between a first position wherein at least a portion of the bottom of the cleaning basin is supported on the support member and at least one dumping position wherein the bottom of the cleaning basin is not supported on the support member.

In accordance with another embodiment of the subject invention, there is provided a washout device for use in connection with a container that has an end with an opening therein. One embodiment of the washout device includes a screen member that is sized to be received in the opening and be suspended therein by at least one hanger that is attached to the support member. This embodiment further includes at least one cleaning basin that is pivotally supported on the screen member and is selectively pivotable about a pivot axis between a first cleaning position and dumping positions. In addition, this embodiment includes a least one pump access opening in the screen member that corresponds to at least one of the cleaning basins and is located through the screen member such that when the corresponding cleaning basin is in the cleaning position, the pump access opening is covered by the cleaning basin.

Another embodiment of the subject invention comprises a washout system that includes a container that has an end with an opening therein. A screen member is supported by the container and covers at least a portion of the opening. At least one cleaning basin is movably affixed to the screen member and is selectively movable between a first cleaning position wherein a portion of the cleaning basin is received on the screen member and other dumping positions wherein the portion of the cleaning basin is not received on the screen member.

Yet another embodiment of the subject invention comprises a method for cleaning objects. The method comprises supporting a washout device on a container that has an end with an opening therein. The washout device may include a support member that has openings therethrough and which is sized to be received in the container opening or span the container opening. At least one cleaning basin is movably affixed to the support member and is selectively movable between a first position wherein at least a portion of a bottom of the cleaning basin is supported on the support member and at least one dumping position wherein the bottom of the cleaning basin is not supported on the support member. The method further includes moving the cleaning basin to the first position and placing a cleaning agent therein. One or more of the objects are placed into the cleaning agent for cleaning. The method also includes moving the cleaned objects from the cleaning agent and moving the cleaning basin to one of the dumping positions wherein the cleaning agent is dumped into the container.

### BRIEF DESCRIPTION OF THE DRAWINGS

In the accompanying Figures, there are shown present embodiments of the invention wherein like reference numerals are employed to designate like parts and wherein:

FIG. 1 is a perspective view of one embodiment of a washout device of the subject invention installed on a conventional 55 gallon drum;

FIG. 2 is a side elevational view of the washout device and drum of FIG. 1 with a portion of the drum removed to illustrate the cleaning basin in a first cleaning position and wherein the cleaning basin is also illustrated in broken lines in a dumping position;

FIG. 3 is a perspective view of one embodiment of a washout device of the subject invention removed from a container and wherein the cleaning basin thereof is shown in a dumping position;

FIG. 4 is another perspective view of the washout device of FIG. 3 with the cleaning basin thereof in a first cleaning position;

FIG. 5 is top view of the washout device depicted in FIG. 3;

FIG. 5A is a top view of another embodiment of the washout device of the present invention; and

FIG. 6 is a side elevational view of the washout device of FIGS. 3 and 4 and illustrating use of a conventional pump through the pump access opening in the support member.

### DETAILED DESCRIPTION OF THE INVENTION

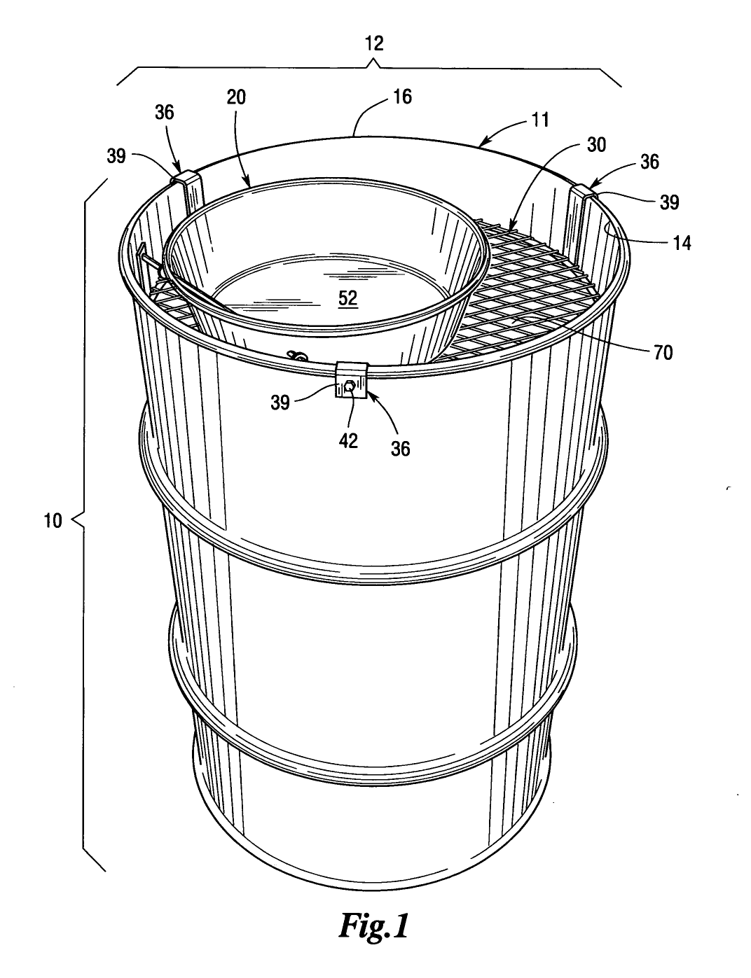

Referring now to the drawings for the purposes of illustrating the present embodiments of the invention only and not for the purposes of limiting the same, FIG. 1 illustrates one embodiment of a washout system 10 of the present invention that may be used to clean a myriad of different tools, items and objects without departing from the spirit and scope of the present invention. For example, the various embodiments of the washout device of the present invention may be used in connection with an appropriate liquid, solid or semisolid cleaning agent to clean paint brushes and rollers, tools, parts and a variety of other objects. As used herein, the term “object” may comprise tools, parts, components, or other objects that have one or more materials (paint, grease, oil, etc.) that needs to be removed therefrom. The types of cleaning agents employed may range from water to a variety of other chemical solvents such as, for example, paint thinner, mineral spirits, degreasing agents, etc. As used herein, the term “cleaning agent” may encompass any of the above listed mediums or any other material or agent that may be used to clean one or more materials from an object. Thus, the scope of protection afforded to the various embodiments of the present invention should not be limited to the types of cleaning agents employed or the types of tools, parts, objects, etc. that may be cleaned by using the various embodiments of the present invention.

Various embodiments of the washout device 20 of the present invention may be used in connection with a container 11 that has an end 12 that has an opening 14 therein. In the embodiment depicted in FIG. 1, the container 11 comprises a conventional 55 gallon drum. As the present Detailed Description continues, however, the reader will appreciate that the various embodiments of the washout device 20 of the present invention may be used in connection with a myriad of different types and shapes of containers that have different capacities without departing from the spirit and scope of the present invention.

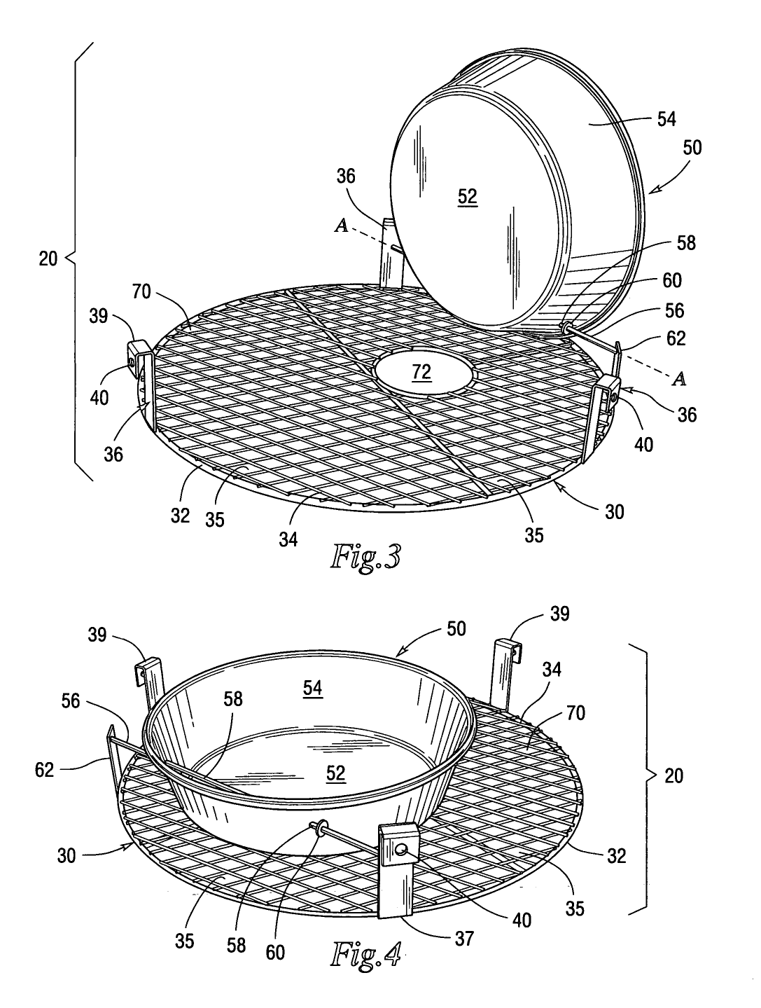

As can be seen in FIGS. 3-5, one embodiment of the washout device 20 includes a cleaning basin 50 that is movably supported by a screen member or other support member 30 that has at least one and preferably a plurality of openings 35 therethrough. In one embodiment, the support member 30 comprises a frame 32 that has a screen 34 attached thereto or supported thereon. In other embodiments, the support member may lack a frame and simply comprise a piece of screen. In one embodiment, the screen 34 is fabricated from expanded steel material having openings 35 therethrough that are approximately one inch in size. Other opening sizes, shapes and configurations may also be employed. For example, the size of the openings 35 may be governed by the size of the objects that are to be cleaned, with it being desirable that the openings 35 be sized to prevent the objects from passing therethrough into the container and thus enable the screen to form a support surface for objects that have been cleaned or are awaiting to be cleaned.

It will also be appreciated that the frame 32 of the support member 30 may be fabricated from a variety of other types of materials such as, for example, stainless, carbon steel, aluminum, polymeric material or combinations of such materials. In addition, the screen 34 may be fabricated from expanded carbon steel material, metal screen material, perforated metal sheet, polymeric screen, steel or other metal screen or perforated material encased or coated in a plastic, rubber or other polymeric materials.

The materials from which the components of the washout devices of the present invention are fabricated from may be largely dependent upon the types of cleaning agents employed and the mediums (paint, grease, chemicals, etc.) that are to be cleaned from the tools, parts or other objects. For example, if the washout device 20 is to be exclusively used to clean latex paint from paint brushes or other water soluble material from parts, the cleaning agent of choice may be water. In other applications, the cleaning agent may be mineral spirits, a degreasing agent or other cleaning chemical or solvent designed to clean a particular type of medium from the object. Thus, the material from which the support member 30 is fabricated may be advantageously selected to prevent the support member 30 from corroding or otherwise decomposing upon contact with certain cleaning agents, solvents, etc. In addition, it is desirable for the support member 30 to be permeable to the type of cleaning agent being used to permit it to be dumped into the container after the cleaning process is completed.

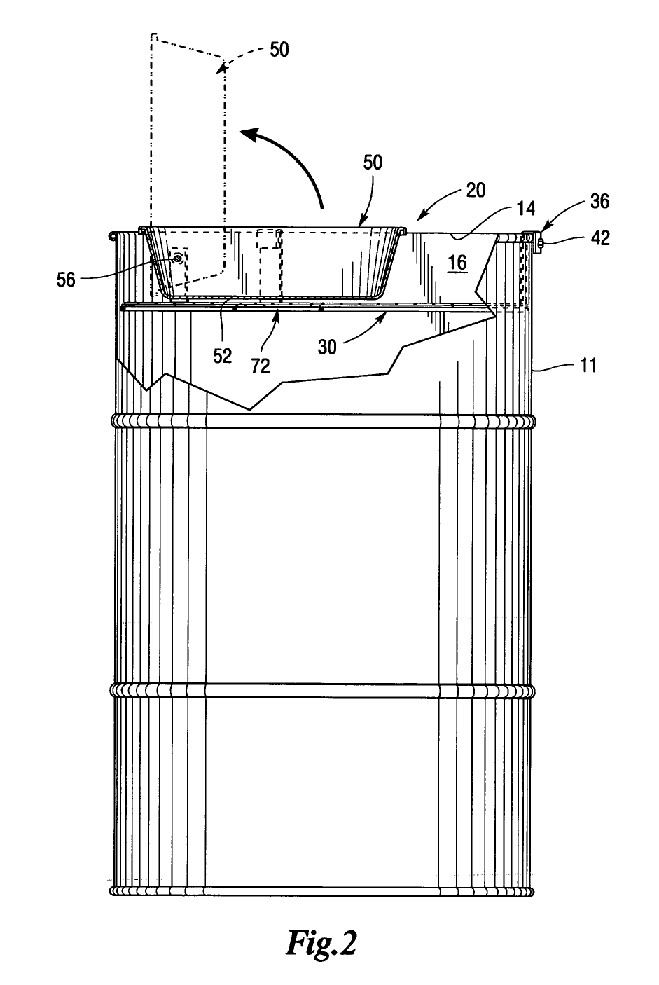

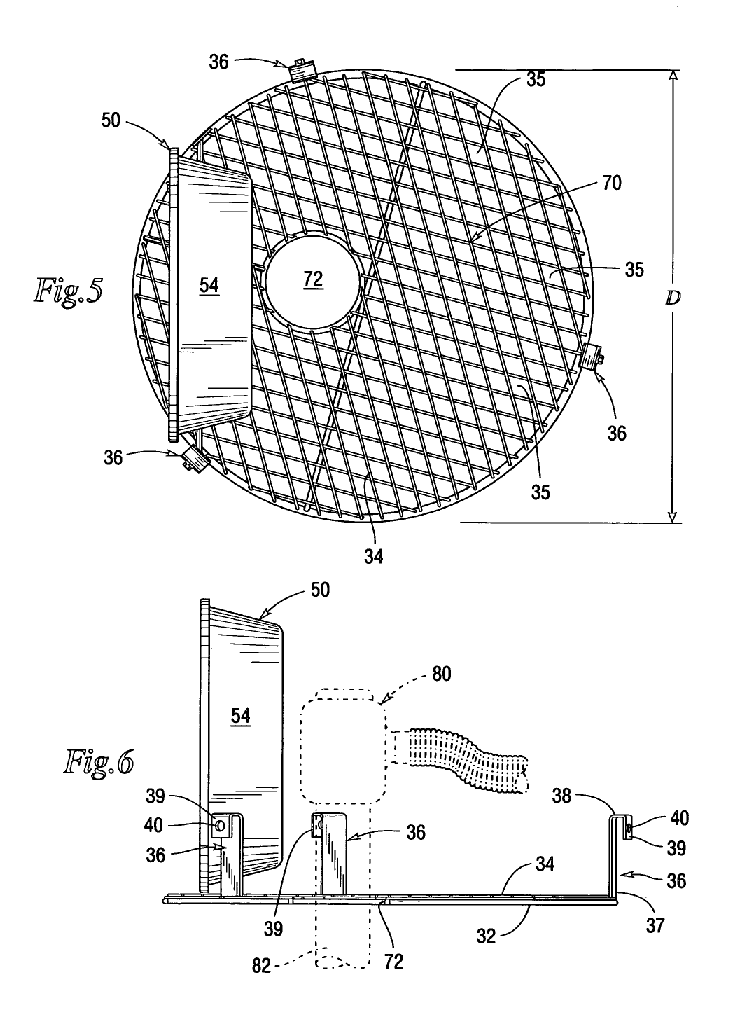

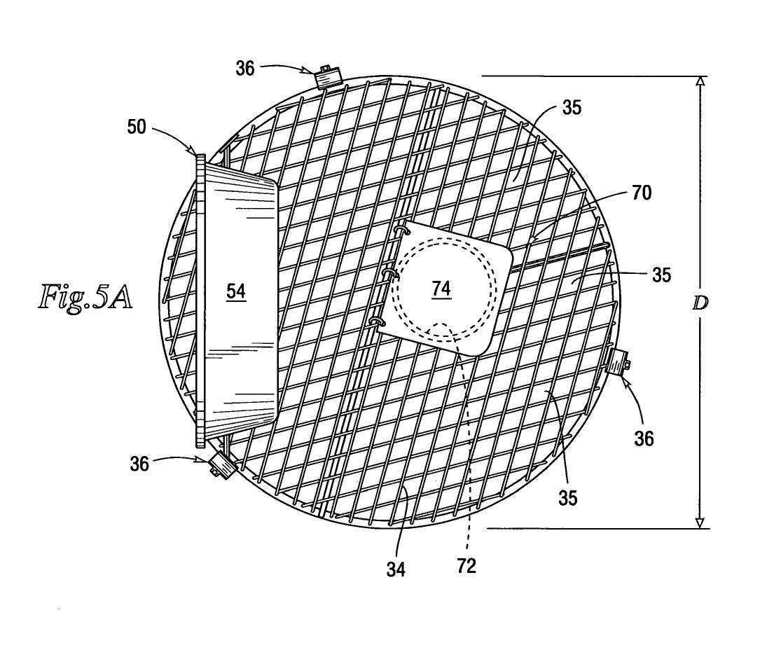

In various embodiments of the present invention, the frame 32 of the support member 30 may have a parametrical shape that closely resembles the shape of the opening 14 in the end 12 of the container 11. In other embodiments wherein the support member lacks a frame, the screen 34 may have a shape that closely resembles the shape of the opening 14. In the embodiment depicted in FIGS. 1 and 2, the container 11 comprises a conventional 55 gallon drum. Thus, in one embodiment, the outer diameter “D” of the support member 30 is approximately twenty-two inches. See FIG. 5. Such arrangement permits the support member 30 to be easily installed in the container 11 without providing a large space between the walls 16 of the container 11 and the outer perimeter of the support member frame 32 through which objects such as tools, parts, etc. may inadvertently fall.

In other embodiments, however, the support member may have a parametrical shape that does not closely resemble the shape of the opening in the container. For example, in applications wherein the container has a rectangular-shaped opening, the support member may have a square shape or other shape. Still in other embodiments, the support member may be sized to span the open end 12 of the container and not extend therein. Thus, the scope of protection afforded to the present invention should not be limited to embodiments wherein the perimeter of the support member closely resembles the shape of the container opening.

In the embodiment depicted in FIGS. 1 and 2, the support member 30 is sized to be received in the opening 14 in the end 12 of the container 11 and be retained therein by a plurality of hangers 36 that are attached to the frame 32 of the support member 30. As can be seen in FIG. 6, one end 37 of the hangers 36 is attached to the frame 32 by welding or other suitable means and the other end 38 has a hook 39 formed thereon that is configured to hook over the open end 12 of the container 11. If desired, one or more of the hangers 36 may be provided with one or more fastener holes 40 for receiving fasteners 42 for attaching the hangers 36 to the container 11. For example, the hangers 36 may be removably attached to the container 11 by screws, bolts, thumbscrews, etc. In the embodiment depicted in FIGS. 1-6, three hangers 36 are employed. The reader will appreciate that other numbers of hangers 36 (including just one) may be employed. It will also be understood that other types of fastener arrangements may be employed to removably or permanently affix the support member to the container. For example, the support member frame 32 could conceivably be welded or glued to the container, depending upon the types of materials that are employed.

The embodiment of the washout device 20 of the present invention that is depicted in FIGS. 1-6, also includes at least one cleaning basin 50 that is pivotally attached to or otherwise supported on the support member 30. In the embodiment depicted in FIGS. 1-6, the cleaning basin 50 is somewhat smaller than the size of the support member 30 to define a “tool support area” 70 for supporting tools, parts, etc. thereon during the cleaning process. In other embodiments, however, the cleaning basin 50 may be larger in size and thus afford little or no space on the support member 30 to support tools or parts thereon while the cleaning basin 50 is in use. In other embodiments, more than one cleaning basin 50 may be used.

The cleaning basin 50 may preferably be sized to receive one or more of the objects, tools, parts, etc. to be cleaned therein such that the user may submerge or otherwise “soak” the objects, tools, parts, etc. in a cleaning agent contained in the cleaning basin 50. In one embodiment, the cleaning basin 50 is fabricated from a polymeric (plastic) material. In other embodiments, however, the cleaning basin 50 may be fabricated from stainless steel, carbon steel, other metals, rubber, nylon or combinations of those materials. Although the cleaning basin 50 depicted in FIGS. 1-6 has a round shape when viewed from above, other shapes of cleaning basins may be employed.

In the embodiment depicted in FIGS. 1-6, the cleaning basin 50 is pivotally supported on the support member 30 and is selectively movable between a “cleaning” position wherein at least a portion of the bottom 52 of the cleaning basin 50 is supported on the support member 30 (FIGS. 1 and 4) and “dumping” positions wherein the cleaning agent may be dumped from the cleaning basin 50 into the container 11 (FIGS. 1 and 3-6). In this embodiment, the cleaning basin 50 is pivotally attached to the support member 30 by a pivot rod 56 that extends through holes 58 in the wall 54 of the cleaning basin 50. In one embodiment, the cleaning basin 50 is retained on the pivot rod 56 by washers 60 or other members attached to (welded) to the pivot rod 56 as shown. See FIGS. 3 and 4. The pivot rod 56 may extend between an upstanding support column 62 that is attached to the frame 32 of the support member 30 by suitable attachment methods, such as, for example, by welding and one of the hangers 36. Such arrangement permits the cleaning basin 50 to be selectively pivoted about pivot axis A-A between a “cleaning position” wherein at least a portion of the bottom 52 of the cleaning basin 50 is supported on the support member 30 and “dumping positions” wherein the cleaning agent may be dumped from the cleaning basin 50 into the container 11. Other fastener arrangements may be employed to movably attach the cleaning basin 50 to the support member 30 without departing from the spirit and scope of the present invention. For example, the pivot rod 56 may be attached to two support columns 62 or the support rod 56 may be attached to two hangers, etc.

To enable the used or spent cleaning agent that contains the waste material, debris, waster, etc. that was cleaned from the objects to be removed from the container 11 for reclamation, further processing and/or appropriate disposal without having to remove the washout device 20 from the container 11, a pump access opening 72 may be provided through the support member 30. See FIGS. 2, 3, 5, and 6. The pump access opening 72 may be sized and shaped to enable the pumping tube 82 of a conventional drum or “bung” pump 80 to be inserted therethrough to pump the contaminated solvent from the container. See FIG. 6. In a preferred embodiment, the pump access opening 72 is located beneath a corresponding cleaning basin 50 when the cleaning basin 50 is oriented in the first cleaning position. See FIGS. 1, 2, and 4. Such arrangement serves to block the pump access opening 72 so that small objects, parts or tools are not inadvertently dropped through the pump access opening 72. In other embodiments, however, the pump access opening may be located in other portions of the support member. If desired, the support member may have a hinged portion to provide access into the container 11.

In yet another embodiment as illustrated in FIG. 5A, the pump access opening 72 may be covered by a flap 74 that is hingedly or otherwise attached to the support member 30. When the use needs to access the opening 72, the flap is pivoted to an open position. The flap may be fabricated from a variety of materials, such as metal rubber, plastic, etc. and be attached to the support member 30 by, for example, wire or other arrangements that facilitate its pivotal travel between a closed position wherein the flap 74 covers the opening 72 and open positions wherein the flap does not cover the opening 72.

This embodiment of the washout device 20 of the present invention may be used as follows. The washout device 20 is installed on the open end 12 of the container 11 by inserting the support member 30 into the opening 14 and supporting it therein by the hangers 36 as shown in FIGS. 1 and 2. If desired, the hangers 36 may be attached to the end of the container 11 by fasteners 42. After the washout device 20 has been mounted on the container 11 or otherwise supported thereon such that at least some portion of the support member 30 spans the opening 14 of the container 11, the cleaning agent may be added to the cleaning basin 50. The objects, tools or other parts may be placed into the cleaning basin 50 and cleaned and washed with the cleaning agent. The support member 30 may be used to support the objects, tools, parts, etc. thereon during the cleaning process.

After the process has been completed or after the cleaning agent has become sufficiently contaminated such that it loses its effectiveness, the user may simply pivot the cleaning basin 50 to positions wherein the cleaning agent and other waste material accumulating in the cleaning basin 50 is dumped through the openings 35 in the support member 30 and into the container 11. The contaminated cleaning agent may be pumped from the container 11 to another container or reclamation vehicle for reclamation and/or disposal by pivoting the cleaning basin 50 to a position wherein the pump access opening 72 is exposed to receive a pumping tube 82 of a conventional pump 80 therethrough. The pump 80 would remove the waste liquid contained in the container and may also remove some of the solid material that is suspended in the liquid. The reader will appreciate that in one embodiment, the cleaning basin 50 pivots away from the pump access opening such that any objects that inadvertently remain in the cleaning basin, prior to dumping Will not be dumped from the cleaning basin in the direction of the pump access opening. In the embodiment depicted in FIG. 5A, the user would simply pivot the flap 74 to an open position to provide access into the opening 72.

In other embodiments, several cleaning basins 50 may be employed in the above manner. In such arrangements, different cleaning agents may be used in each cleaning basin 50, if desired.

The reader will appreciate that the various embodiments of the washout system of the present invention are particularly well-suited for residential use. For example, the washout system 10 including the container 11 may be provided to a homeowner and positioned such that a pumping service may periodically access it to pump the waste liquids from the container. Such service would employ a truck or other mobile vehicle that had a tank or several tanks (for different types of fluids) and a means for pumping the waste liquid from the container 11 into the appropriate tank for transport from the residence to a location for reclamation or appropriate disposal. The pumping service may be provided on a predetermined periodic schedule or it may relay on the homeowner to inform the pumping service that the container needs to have the waste liquid removed therefrom.

In applications wherein solid materials accumulate in the container, the pumping service would replace those containers that were full of solid materials with empty containers and haul the full containers to another location wherein the solid material could be reclaimed or otherwise disposed of. For example, when a container is full of solid waste, the washout device may be removed from the container to enable a lid to be attached to the container. The container may then be further prepared as necessary for transport to a land fill or other appropriate location.

The unique and novel construction of various embodiments of the washout system of the present invention provides numerous advantages for use in building applications. For example, the common types of containers such as 55 gallon drums may be employed. Such containers may be relatively easily moved when empty and may be manipulated and transported utilizing existing material handling equipment when they are full. Thus, the portability of various embodiments of the subject washout systems of the present invention is one advantage which makes the subject invention well-suited for use at construction sites. Another advantage is that the support member prevents access by children and/or pets into the waste material contained within the container.

In applications wherein different types of waste liquids and solids are used which require different methods of reclamation or disposal, different types, shapes, colors, etc. of containers may be used to distinguish between the types of waste materials. For example, if one washout system is used to clean latex paint and another washout system is employed to clean a grease or oil from parts that require reclamation and/or disposal procedures that differ from the reclamation and/or disposal procedures used for waste latex paint, then the container for washout system used in connection with the oil and grease may have a color, shape, size, type, etc. that differs from the color, shape, size, type, etc. of container employed to collect the waste latex paint and cleaning water. Thus, the above-described method of the present invention could also be used in connection with commercial applications.

In accordance with one method of the present invention, as the washout system of the present invention is used to clean tools, parts, etc., the “spent” or used liquid cleaning agent will be accumulated in the container. The solid waste materials tend to pass through the spent liquid to the bottom of the container to accumulate therein. After the container becomes full or contains a certain capacity of spent liquid cleaning agent, the liquid cleaning agent is pumped from the container into another container for removal from the jobsite. During the pumping of the spent liquid from the container, some of the sold waste materials may also be removed through the pump for disposal thereof. Those solids, however, that remain after the liquid has been pumped out of the container will continue to accumulate in the container. After the liquid cleaning agent has been removed from the container, the container can be used again until the container requires the spent liquid cleaning agent to be pumped therefrom. This process is repeated until the accumulation of solid waste material reaches a level wherein a new container is warranted. The full container may then be removed from the jobsite for proper disposal thereof. The pumping service then provides the user with an empty container. In one method, the user monitors the accumulation of liquid and solids in the container and then notifies the pumping service when the liquid must once again be pumped from the containers or the container must be replaced with an empty container. In other methods, the pumping service pumps the spent cleaning liquid from the containers in accordance with a predetermined service schedule.

The various embodiments of the subject invention represent effective devices for cleaning a variety of tools, parts, etc. The portable nature of some embodiments of the subject invention make it easily transferable between containers such that one washout device may be used with several different containers. In other embodiments, however, the washout device of the subject invention may be permanently attached to the container.

The invention which is intended to be protected is not to be construed as limited to the particular embodiments disclosed. The embodiments are therefore to be regarded as illustrative rather than restrictive. Variations and changes may be made by others without departing from the spirit of the present invention. Accordingly, it is expressly intended that all such equivalents, variations and changes which fall within the spirit and scope of the present invention as defined in the claims be embraced thereby.

What is claimed is:

1. A washout device for use in connection with a container having an end within an access opening therein, said washout device comprising:
a support member having at least one opening therethrough, said support member sized to be received in the access opening in the container; and
at least one cleaning basin movably affixed to said support member and being selectively movable between a first position wherein at least a portion of a bottom of said cleaning basin is supported on the support member and at least one dumping position wherein said bottom of said cleaning basin is not supported on said support member.

2. The washout device of claim 1 wherein said support member is fabricated from material selected from the group of materials consisting of expanded metal material, expanded polymeric material, perforated metal material, perforated polymeric material, metal screen and polymeric screen.

3. The washout device of claim 1 wherein said support member is suspended within the access opening of the container by at least one hanger attached to the support member, each said hanger having a hook portion thereon.

4. The washout device of claim 3 wherein each hook portion has at least one fastener hole therethrough to receive a fastener for attaching the hook portion to the container.

5. The washout device of claim 1 further comprising at least one pump access opening through said support member.

6. The washout device of claim 5 wherein at least one pump access opening is located in said support member such that when a corresponding one of said cleaning basins is in said first position, said bottom of said corresponding cleaning basin covers said pump access opening.

7. The washout device of claim 1 wherein at least one of said cleaning basins is pivotally attached to said support member.

8. The washout device of claim 7 wherein said at least one of said cleaning basins comprises a bottom portion and a wall portion attached to said bottom portion and wherein said cleaning basin is pivotally attached to said support member by a pivot rod extending through portions of said wall portion and being attached to said support member by at least one column member.

9. The washout device of claim 1 wherein said support member is sized to span the opening of the container.

10. The washout device of claim 1 wherein said support member is permanently affixed to the container.

11. A washout device for use in connection with a container having an end with an access opening therein, said washout device comprising:
a screen member sized to be received in the access opening and be suspended therein by at least one hook assembly attached thereto;
at least one cleaning basin pivotally supported on said screen member and being selectively pivotable about a pivot axis between a first cleaning position and dumping positions; and
at least one pump access opening through said screen member, said pump access opening corresponding to at least one said cleaning basin and being located through said screen member such that when said corresponding cleaning basin is in said cleaning position, said pump access opening is covered thereby.

12. A washout system, comprising:
a container having an end with an access opening therein;
a screen member affixed to said container and covering at least a portion of said access opening; and
at least one cleaning basin movably affixed to said screen member and being selectively movable between a first cleaning position wherein a portion of said cleaning basin is received on said screen member and other dumping positions wherein said portion of said cleaning basin is not received said screen member.

13. The washout system of claim 12 wherein said container comprises a 55 gallon drum.

14. The washout system of claim 12 further comprising at least one pump access opening through said screen member.

15. The washout system of claim 12 wherein said access opening in said container has a parametrical shape and wherein said screen member has a parametrical shape similar to said parametrical shape of said opening.

16. A method for cleaning objects, said method comprising:
supporting a washout device on a container having an end with an access opening therein and wherein the washout device comprises:
a support member having at least one opening therethrough and being sized to be received in the access opening of the container; and
at least one cleaning basin movably affixed to the support member and being selectively movable between a first position wherein at least a portion of a bottom of said cleaning basin is supported on the support member and at least one dumping position wherein the bottom of the cleaning basin is not supported on the support member;
moving the cleaning basin to the first position;
placing a cleaning agent into the cleaning basin;
placing one or more of the objects into the cleaning agent;
removing the cleaned object from the cleaning agent; and
dumping the cleaning agent into the container.

17. The method of claim 16 wherein said dumping comprises pivoting the cleaning basin to a dumping position.

18. The method of claim 16 wherein the support member has a pump access opening therethrough and wherein said method further comprises:
inserting a portion of a pump through the pump access opening; and
pumping the dumped cleaning agent from the container.

19. The method of claim 18 wherein said inserting and said pumping are accomplished when the cleaning basin is in one of the dumping positions.

20. A method for cleaning waste material from an object, the method comprising:
providing a container;
providing a washout device on the container, the washout device comprising:
a support member having at least one opening therethrough, said support member sized to be received in an access opening in the container; and
at least one cleaning basin movably affixed to said support member and being selectively movable between a first position wherein at least a portion of a bottom of said cleaning basin is supported on the support member and at least one dumping position wherein said bottom of said cleaning basin is not supported on said support member;
providing a liquid cleaning agent in the cleaning basin for removing the waste material from the object;
placing the object in the cleaning agent to remove the waste material therefrom;
dumping the cleaning agent and solid waste material removed from the object into the container; and
pumping the liquid cleaning agent from the container after a predetermined amount of liquid cleaning agent has accumulated in the container.

21. The method of claim 20 wherein said pumping is performed on a periodic basis.

22. The method of claim 20 further comprising replacing the container after a predetermined amount of solid waste material has accumulated in the container.
